(19) United States
(12) Patent Application Publication
(10) Pub. No.: US 2004/0175585 A1
(43) Pub. Date: Sep. 9, 2004

(54) Barium strontium titanate containing multilayer structures on metal foils

(76) Inventors: Qin Zou, North York (CA); Gerhard Hirmer, Aurora (CA); George Xing, Toronto (CA)

Correspondence Address: LOCKE LIDDELL & SAPP LLP, 600 TRAVIS, 3400 CHASE TOWER, HOUSTON, TX, 77002-3095, US

(21) Appl. No.: 10/382,307

(22) Filed: Mar. 5, 2003

(51) Int. Cl. B32B 15/04

(52) U.S. Cl. 428/469; 428/701

(57) ABSTRACT

The invention relates to multilayered structures having a crystalline or partially crystalline barium strontium titanate (BST) dielectric thin film composites and a metallic foil substrate. A barrier layer may be interposed between the metallic foil substrate and dielectric thin film. In addition, the invention relates to a capacitor comprised of the multilayer structure containing such composites.

### FIELD OF THE INVENTION

The invention relates to crystalline barium strontium titanate dielectric containing multilayered structures having a metallic foil substrate. The multilayered structures may further include a barrier layer or a buffer layer between the dielectric and metallic substrate. In addition, the invention relates to multilayer structures produced from such thin film composites and to supercapacitors containing the same. The supercapacitors include microminiature, large capacitance capacitors especially for microwave devices application and embedded passive components. The invention further relates to a method of preparing the dielectric thin film composites and multilayer structures. The thin film composites can be prepared by deposition of barium strontium titanate (BST) thin films on selected metal substrates such as platinum, titanium, nickel, stainless steel, copper, and brass foils using sol-gel spin-coating/dipping deposition technology, sputtering deposition methods, or metal-organic chemical vapor deposition technology.

### BACKGROUND OF THE INVENTION

With the ever-increasing scale of integration and electronics miniaturization, a need has arisen for new dielectric materials with high dielectric constants suitable for replacing conventional silicon oxide/nitride dielectrics. Although lead zirconate-titanate (PZT) is a potential material suitable for memory capacitors and supercapacitors due to its high dielectric constant, it is unsuitable for microwave frequency applications due to the fact that its dielectric constant drops to 40 at about 1 GHz from about 1300 at 1 MHz and loss tangent diverging to 10% at 1 GHz at room temperature.

BST materials are an excellent material for memory capacitor applications due to its high dielectric constant, low dielectric loss, low leakage current and high dielectric breakdown strength (D. Roy and S. B. Krupandidhi, Appl. Phys. Lett., Vol.62, No.10; 1993; p. 1056). Also, by tailoring Ba/Sr ratio in the composition, the curie temperature can be shifted, leading to ensure that the electrical properties remain relatively constant over the temperature range. As a result, BST materials have attracted considerable interest as candidate materials for a variety of potential applications in the sensor, computer, microelectronics, and telecommunication device industries such as high density capacitors integrated on dynamic random access memories (DRAMs), monolithic microwave integrated circuits (MMICs), and uncooled infrared sensing and imaging devices and phase shifter (W. J. Kim and H. D. Wu, J. Appl. Phys., Vol. 88; 2000; p. 5448).

Currently, substrates commonly used for BST thin films are silicon wafer, MgO or LaAlO₃ single crystal, sapphire, and glass. When used with noble-metal electrodes (such as Pt, Au, Ir, etc.), such substrates have a limited range of potential applications. Alternative structures are desired which permit high frequency operation range, low dielectric loss, high ESR, and exhibiting flexibility for embedded capacitor systems. For example, in embedded thin film high-K dielectrics packages (such as high density PCB and MCM-Ls), base-metal foils can be used as both the carrier substrate and electrode to minimize cost. Previous attempts at depositing dielectric thin films on metal substrates have been reported in the literature. For example, Saegusa (Japanese Journal of Applied Physics, Part 1, Vol. 36, no.11; 1997; p.6888) reported on deposition of PZT films modified with lead borosilicate glass on aluminum, titanium and stainless steel foils; WO 01/67465 A2 recites PZT deposited on titanium, stainless, nickel, and brass foils. The results in these efforts are promising; however, they do not exhibit the requisite property needs for commercial application.

### SUMMARY OF THE INVENTION

The invention relates to multilayered composites having a crystalline or partially crystalline barium strontium titanate (BST) dielectric thin film and a metallic foil substrate. In a preferred embodiment, the multilayered composite contains a barrier layer and/or buffer layer interposed between the metallic foil substrate and barrier strontium titanate dielectric thin film.

Such multilayer structures can be prepared, for example, by depositing BST thin films on base-metal foils, such as nickel, titanium, stainless steel, brass, nickel, copper, copper coated nickel or silver thin layer, using various methods such as sol-gel spin-coating/dipping deposition technology, sputtering deposition methods, or metal-organic chemical vapor deposition technology. The crystalline BST dielectric thin films of the invention include poly-crystalline composites of a nanometer to sub-micrometer scale.

The multilayered structure of BST dielectric thin films on metal foils of the invention exhibit excellent properties for capacitors, including high capacitance density (200-300 nF/cm²) at 10 kHz frequency, low dielectric loss (<3% at 10 kHz frequency) and low leakage current density (˜10⁻⁷ A/cm² at 5V) and high breakdown strength (>750 kV/cm) at room temperature. In addition, the multilayer structures of the invention exhibit 20% tunability calculated in Cₒ-Cᵥ)/C₀ from capacitance-voltage curve at 10 kHz frequency, promising for microwave applications.

### BRIEF DESCRIPTION OF THE DRAWINGS

FIG. 1 is a schematic drawing of various configurations for multilayer structures of dielectric thin films on metal foils.

FIG. 1(a) is a multilayer structure composed of a crystalline dielectric thin film deposited on a metal foil.

FIG. 1(b) is a multilayer structure composed of multiple crystalline dielectric thin film deposited on a metal foil.

FIG. 1(c) is a multilayer structure composed of a single or multiple different crystalline dielectric thin film deposited on a metal foil having a barrier layer between the dielectric film and a metal foil.

FIG. 1(d) is a multilayer structure composed of a single or multiple different crystalline dielectric thin film deposited on a metal foil having a buffer layer(s), and/or various barrier layers interposed between the dielectric film and a metal foil.

FIG. 2 shows an X-ray diffraction (XRD) measurement result of the BST (70/30) film on copper foil annealed at 600° C. for 30 minutes (Sample Ni/Cu 600).

FIG. 3 shows the surface morphology of the BST (50/50) film on Ni foil annealed at (a) 550°, (b) 600° C., and (c) 650° C. for 30 minutes and (d) cross-section of BST (50/50) film on the Ni foil annealed at 600° C. (Sample Ni 600).

FIG. 4 shows the effect of annealing temperature on the capacitance density and dielectric loss of BST films deposited on selected metal foils.

FIG. 5 shows the capacitance and loss tangent as a function of frequency for BST films on selected metal foils.

FIG. 6 shows the capacitance as a function of DC bias voltage for BST films on (a) titanium foil (Ti 650), (b) nickel foil (Ni 600), (c) copper with nickel layer foil (Ni/Cu 600), and (d) stainless steel (SS 600), at 1 MHz and room temperature.

FIG. 7 shows the current-voltage curve for the BST films on titanium (Ti 650), nickel (Ni 600), and copper (Ni/Cu 600) foils.

### DETAILED DESCRIPTION OF THE PREFERRED EMBODIMENTS

A multilayer structure comprises the crystalline dielectric thin film and a metallic foil. The metallic foil serves as both substrate and electrode. The multilayered structure may contain a barrier layer interposed between the dielectric thin film and metallic foil. In a preferred embodiment, the barium strontium titanate dielectric thin film and metallic foil substrate comprises a parallel interconnection of dielectrics and metal foil systems.

The metal of the metallic foil should possess a high melting point and oxidation resistibility due to the requirement of high firing temperatures and oxidizing atmospheres for oxide dielectrics. In addition, it should exhibit a close match of thermal expansion coefficient to BST dielectric films to avoid film crack, show low reactivity with BST to obtain higher dielectric constant and low loss, and permit good adhesion with BST. Compared with PZT dielectric thin films, the crystalline temperature of BST dielectric film is higher, leading to smaller selection ranges for suitable metallic foils. In a preferred embodiment, titanium, nickel and stainless steel (SUS304) foils having a melting point of at least 850° C. are preferably used as substrates of BST dielectric thin films. Preferred as the metallic substrate is titanium, stainless steel, brass, nickel, copper, copper nickel and silver foil. The metallic foil substrate is further preferably a flat surface, texture surface or macroporous.

Alternatively, a buffer layer may be interposed between the dielectric thin film and metallic foil in the pressure or absence of a barrier layer. When present, the barrier layer is preferably a metallic layer, a conductive oxide, a dielectric layer or a ferroelectric layer. The metallic layer may be, for example, platinum, titanium or nickel. Suitable as the conductive oxide layer are those selected from LaNiO₃, IrO₂, RuO₂, and La_{0.5}Sr_{0.5}CoO₃. Suitable dielectric layers are those selected from TiO₂, Ta₂O₅, and MgO. The ferroelectric layer may preferably be selected from barium titanate, lead titanate, or strontium titanate.

In a preferred embodiment, the dielectric material is of the formula (Ba₁₋ₓSrₓ)TiO_{y} wherein 0≦x≦1.0, preferably x is between from about 0.1 to about 0.9, most preferably 0.4 to about 0.75, y is from about 0.50 to about 1.3, preferably from about 0.95 to about 1.05 and z is from about 2.5 to about 3.5. The inorganic oxides forming the dielectric are bonded to the foil substrate and exhibit a perovskite crystalline lattice. They may further exhibit dielectric, ferroelectric and/or paraelectric properties through making use of the curie points dependence on x.

In a preferred embodiment, one or more thin layers are incorporated between the thin film and the metal foil, functioning as barrier layers and/or various buffer layers and/or seed layers. These thin layer(s) can benefit to crystalline growth to low firing temperature, block the diffusion of metal ions of the foil, and buffer stress due to mismatch of thermal expansion coefficients to avoid crack, in one side or several sides. The thin layers incorporated between the dielectric thin film and the metal foil may be selected from other metal materials (such as Ni layer electrochemically coated on copper foil), conductive oxides (such as LaNiO₃ layer sol-gel spin-coated on titanium foil), or dielectric oxides (such as TiO₂ layer, lead titanate layer).

The multilayered composite has a thickness of between from about 10 nm to about 2 μm. Generally, the thickness of the metallic foil is less than 0.1 mm.

In general, the BST is deposited as an amorphous oxide of random orientation or is at least partially crystalline. In order to enhance dielectric properties of films, film crystallinity is preferred and a post deposition thermal treatment is used. This can be accomplished by rapid thermal annealing using quartz halogen lamps, laser-assisted annealing (such as that wherein an excimer or carbon dioxide laser is employed) or an electron beam annealing.

The BST dielectric thin films/composites of the invention may be prepared using sol-gel process. Compared to other thin-film deposition techniques, sol-gel process offers some advantages: homogeneous distribution of elements on a molecular level, ease of composition control, high purity, and ability to coat large and complex area substrate. In addition, the sol-gel process in the invention employs low firing temperature. The temperatures for crystalline BST thin films on other substrates are normally between 600° C. and 850° C. Whereas, BST dielectric films deposited on a metal substrate require a low firing temperature to minimize interdiffusion, reaction between the foil and the dielectric film, and oxidation of the metal foil. Wherefore, the firing temperature for the multilayer structure of the invention is preferably between 550° C. and 700° C.

The BST solutions for sol-gel process the invention may be synthesized by using starting materials, such as barium acetate [Ba(OOCH₃)₂], strontium acetate [Sr(OOCH₃)₂.0.5H₂O], and titanium isopropoxide [Ti(O-iC₃H₇)₄]. In a preferred embodiment, the BST (x=0 to 0.8) precursor is prepared by mixing barium acetate and strontium acetate in a ratio, dissolving into acetic acid with methanol in a ratio of 1:1, heating to 105° C. for 30 minutes to about one hour to dehydrate in a reflux system under a vacuum of about 5×10⁻² Torr and then cooling down to room temperature. Titanium isopropoxide in 3-methyl butanol may be admixed and heated to 120° C. for about 2 to 3 hours under a vacuum of about 5×10⁻² Torr. Diethanolamine (DAE) and 2-ethylhexanoic acid may be added as additives in order to increase stability, avoid film cracking, and adjust wettability to the foil substrate. The solution may be concentrated to 0.25M and proper water added for hydrolysis. The stock polymer precursor can be diluted with toluene and alcohol to desired coating concentration.

The BST solution is deposited using spin-coating technology on various metal foils, such as titanium foil (thickness, d, is 30 μm, surface roughness, Ra, is 100 nm); SUS304 stainless steel foil (d=50 μm, Ra=200 nm); nickel foil (d=30 μm, Ra=200 nm); or copper foil coated with 1.5˜2 μm nickel barrier layer (d=25 μm, Ra=100 nm). Before deposition the foils should be cleaned, such as by using acetone (in an ultrasonic cleaner), to remove oil. The spin speed used is typically 2000 rpm for 30 s. Each spin on the layer is dried at 150° C. for 2˜5 min and then baked at 350° C. for 5˜10 min on the hot plate with a vacuum chuck for baking uniform to volatize the organic species. The thickness of single coating layer may be about 50 nm to 150 nm, dependent on the spin rate, the concentration and viscosity of the solution. Multiple coatings may be required for increasing film thickness. The deposited films may be fired (annealed) at 550˜650° C. for 30 min using rapid thermal annealing (RTA) until crystallization. Higher firing temperatures tend to form completed perovskite crystalline and increase the average grain size in the films, but may result in serious interdiffusion and/or oxidation of metal foils.

The capacitors made of the multilayer structure of barium strontium titanate dielectric thin film on metal foil of the invention may have a dielectric constant of 100˜300, a loss tangent (dielectric loss) less than 3% at 10 kHz frequency, a leakage current density less than 10⁻⁷ A/cm at a 5V operating voltage, and a breakdown field strength of from about 750 kV/cm to about 1.2 MV/cm at room temperature.

### EXAMPLES

### Example 1

The starting materials of the precursor preparation for BST dielectric thin film are barium acetate [Ba(OOCH₃)₂], strontium acetate [Sr(OOCH₃)₂.0.5H₂O], titanium isopropoxide [Ti(O-iC₃H₇)₄].

The BST (x=0.3) polymer precursor is prepared by mixing barium acetate and strontium acetate in a ratio, dissolving into acetic acid with methanol in a ratio of 1:1, and heating to 105° C. to dehydrate in a reflux condenser under a vacuum and then cooling down to room temperature. A clear Ba+Sr solution was obtained. Following, an equimolar amount of titanium isopropoxide in 3-methyl butanol was added into Ba+Sr solution, and the mixture was heat at 120° C. for about 2 to 3 hours in a reflux condenser under a vacuum. With this precursor solution diethanolamine (DAE) and 2-ethylhexanoic acid have been added as additives in order to increase stability, avoid the film cracking, and adjust wettability to the foil substrate. Finally, the precursor solution was concentrated to 0.25M and proper water was added for hydrolysis. The composition of the solution was (Ba_{0.7}Sr_{0.3})TiO₃ [BST(70/30)]. The stock polymer precursor can be diluted with toluene and alcohol to desired coating concentration. Similar solutions can be prepared of a BST (50/50).

A 0.15M BST solution was then deposited using spin-coating technology onto:

Titanium foil (thickness, d, is 30 μm, surface roughness, Ra, is 100 nm);

SUS304 stainless steel foil (d=40 μm, Ra=200 nm);

Nickel foil (d=30 μm, Ra=200 nm);

Copper foil coated with 1.5˜2 μm nickel barrier layer (d=25 μm, Ra=100 nm).

Before deposition, the foils were ultrasonically cleaned in acetone, methanol and rinsed in deionized water, followed by a dying process. The spin speed was 2000 rpm for 30 s. Each spin on the layer is dried at 150° C. for 2 min and then baked at 350° C. for 10 min on the hot plate with a vacuum chuck for baking uniform to remove volatile components. The thickness of single coating layer may be about 100 nm. Multicoated BST films were prepared by the repetitions of above deposition process up to desired film thickness.

The deposited films were fired (annealed) at 550˜650° C. for 30 min using rapid thermal annealing (RTA) until crystallization. Higher firing temperatures tend to form completed perovskite crystalline and increase the average grain size in the films, but may result in serious interdiffusion and/or oxidation of metal foils.

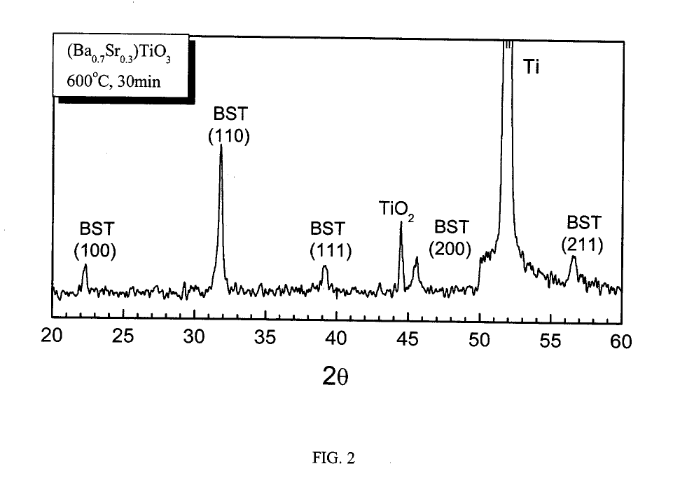

FIG. 2 shows X-ray diffraction (XRD) pattern of the BST(70/30) film on titanium foil annealed at 600° C. for 30 min. The film has typical perovskite structure and random crystalline orientation.

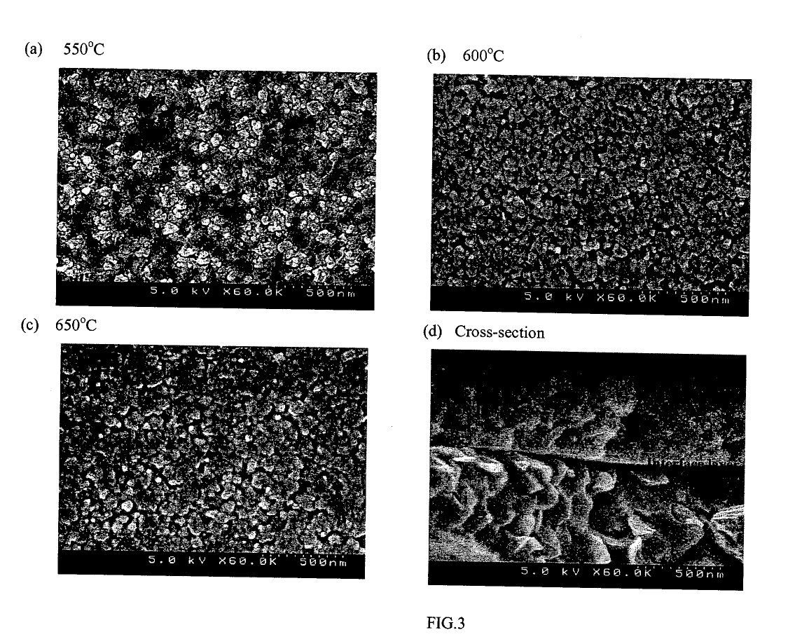

FIG. 3(a) to (c) shows the surface morphology of the BST (50/50) film on Ni foil annealed at 550° C., 600° C., 650° C. for 30 min and figure (d) shows cross-section of BST(70/30) film on the Ni foil annealed at 600° C. The films consisted of perovskite single phase fine granular grains and the grain size was about 40-60 nm. The surface of the BST film on Ni foil annealed at 550° C. showed an uncompleted crystalline. The completed and uniform crystalline of the film could be observed a higher than 600° C. From FIG. 3(d), a ˜20 nm interface layer between the BST film and the Ni foil can be observed.

X-ray photoelectron spectroscopy (XPS) depth profile analysis have shown that the oxide layer, even diffusion layer (also called an interface layer) was formed between the BST dielectric film and the foil, i.e. TiOₓ on Ti foil, NiOₓ on Ni foil or Ni layer on Cu foil, Ni and/or Cr diffusion into the stainless steel foil or the Ni foil. The combination of these low-permittivity interface layers and the stress between films and foils likely contributes to relatively low dielectric constant of films on metal foils (compared to that of BST films on Pt/silicon substrate).

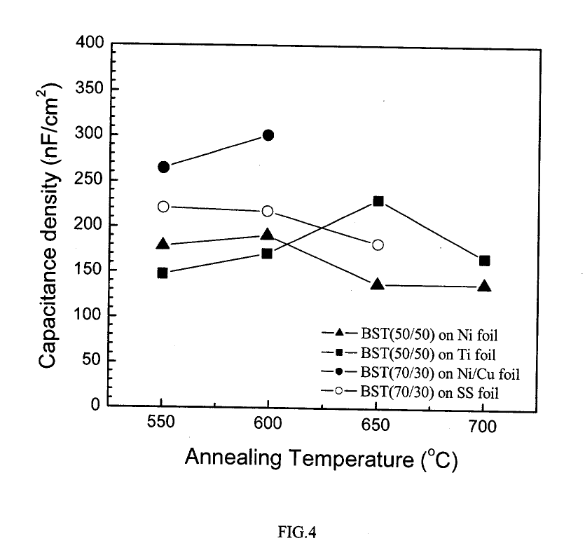

The multilayer structures of BST films on selected metal foils were electrically measured at room temperature at zero bias with modulation voltage of 0.5V and 1 MHz frequency. The effect of annealing temperature on the capacitance density of BST films deposited on metal foils is demonstrated in FIG. 4. For BST(50/50) films on Ti foil, an optimum annealing temperature was about 650° C.; for BST(50/50) on the Ni foil and BST(70/30) on the copper foil with Ni layer were at 600° C., at which higher capacitance density and lower loss tangent were obtained. Above these temperatures, decreased capacitance and increased loss may be attributed to increased thickness of interface layer (such as TiOx, NiOx, Ni and/or Cr diffusion) and stress of the foil with annealing temperature (for example, increased hardness of Ti foil with annealing temperature).

A good example of barrier layer is BST films on copper foils. Usually, the oxidation of copper easily happens at low temperature (˜200° C.) in air environment, which is difficult and not suitable as a substrate to obtain the complex crystal structure (i.e. perovskite) common to high-K materials. The diffusion of copper ions into dielectric films may further result in low insulating properties. When nickel layer of about 1˜2 μm thickness was coated on copper, the oxidation of copper was restrained and the diffusion of copper was effectively blocked off, which has been testified from XPS depth profile analysis. As a result, the appropriate electrical properties for capacitor application were obtained.

### Example 2

BST precursors with 0.15M concentration were prepared as set forth in Example 1. 500 nm thick BST dielectric films were deposited using spin-coating technology onto:

Titanium foil (thickness, d, is 30 μm, surface roughness, Ra, is 100 nm);

SUS304 stainless steel foil (d=50 μm, Ra=200 nm);

Nickel foil (d=30 μm, Ra=200 nm);

Copper foil coated with 1.5˜2 μm nickel barrier layer (d=25 μm, Ra=100 nm), wherein nickel layer was electrochemically deposited.

After annealed at 600° C. for, 20-40 min, 7.5×10⁻³ cm² area Au was evaporated the surfaces of films as top electrode for dielectric properties measurement. The capacitance-frequency (C-f), capacitance-voltage (C-V) and current-voltage (I-V) measurements were performed using a HP4294AR Precision Impedance Analyzer and a Keithley 6517A Electrometer at room temperature.

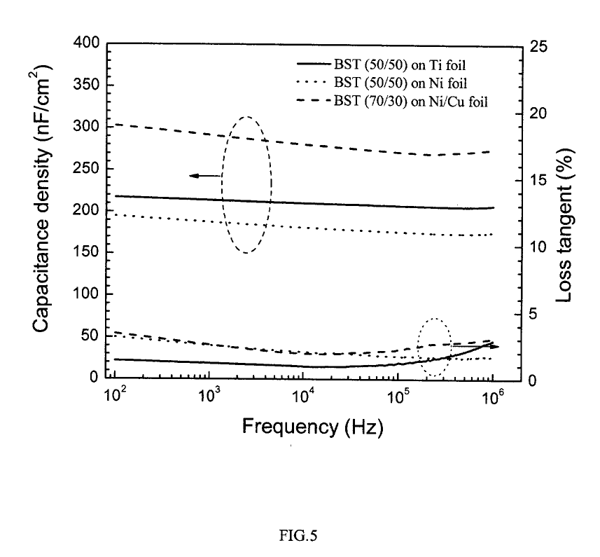

FIG. 5 shows the capacitance and loss tangent as a function of frequency for BST films on the selected metal foils. These capacitors made of the multilayer structures of BST films on metal foils exhibit excellent frequency, with the dielectric constant remaining virtually constant up to 1 MHz. They may/can be used in high frequency applications. The capacitor based on BST films on stainless steel (SS600) exhibit worse dielectric properties at low frequency, very high DC leakage current indicates serious diffusion of metal ions in stainless steel foil into the BST film.

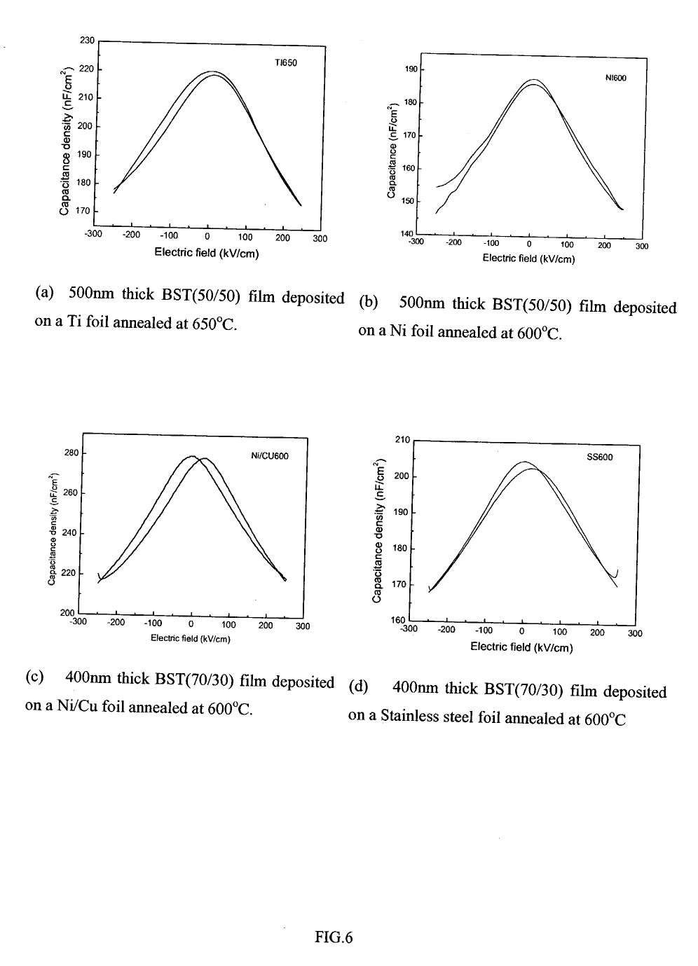

FIG. 6 shows the capacitance as a function of DC bias voltage for BST films on various selected metal foils at 1 MHz. The voltage swept from negative to positive and swept back. Almost nonhysteretic and symmetric curves indicate the curie points below room temperature, i.e. paraelectric phase. Slightly nonhysteretic responses reflect probably trap effect due to interface layers and stress between the films and the foils.

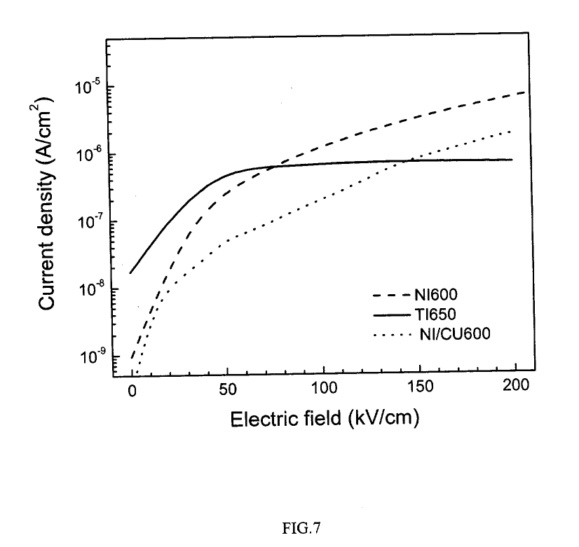

FIG. 7 shows the current-voltage curve for the BST films on various selected metal foils. At an applied voltage of 5 V, which corresponds to an applied field of about 100 kV/cm, the leakage current densities are ˜10⁻⁷ A/cm² order for Ti 650, Ni 600 and Ni/Cu 600 samples. The low current density of the multilayer structures of BST films on the metal foils demonstrates that the sol-gel derived BST films from spin-on solution have good insulting properties.

Table 1 summarize the measurement results of the dielectric properties of multilayer structures of BST thin film on the selected above foil substrates:

TABLE 1

| | | | | | | Leakage | |
|---|---|---|---|---|---|---|---|
| | | Annealing | | Capacitance | Loss | current | Breakdown |
| Foil | Ba/Sr | temperature | Sample | density | tangent | (A/cm²) | strength |
| substrate | ratio | (° C.) | code | (nF/cm²) | (%) | @5 V | (kV/cm) |
| Titanium | 50/50 | 650 | TI650 | 230 | 1.3 | 4 × 10⁻⁷ | 1000 |
| Nickel | 50/50 | 600 | NI600 | 190 | 2.1 | 8 × 10⁻⁷ | 900 |
| Copper | 70/30 | 600 | NI/CU600 | 280 | 2.3 | 2 × 10⁻⁷ | 750 |
| (with 2 μm | | | | | | | |
| Ni layer) | | | | | | | |
| Stainless | 70/30 | 600 | SS600 | 260 | 15 | 5 × 10⁻⁶ | 500 |
| steel | | | | | | | |
| (SUS304) | | | | | | | |

The examples show the fabrication of BST film on titanium, nickel, stainless steel and cupper (with nickel barrier layer) foils, using sol-gel processing and annealing. BST films on the selected metal foils were crack-free, and strong adhesion without any signs of delamination. The capacitors made of the multilayer structures were obtained with relatively high capacitance density (200˜300 nF/cm²), low dielectric loss tangent (<3%), low leakage current density (˜10⁻⁷ A/cm² at 5V) and high breakdown field strength (>750 kV/cm). Excellent high frequency properties and C-V characteristics were exhibited.

Various modifications may be made in the composition of BST and arrangement of the various elements, incorporation of barrier layers, steps and procedures described herein without departing from the spirit and scope of the invention as defined in the following claims.

What is claimed is:

1. A multilayer composite comprising:
a metallic foil substrate;
a crystalline or partly crystalline barium strontium titanate dielectric thin film.

2. The multilayer composite of claim 1, further comprising a barrier layer interposed between the metallic foil substrate and the dielectric thin film.

3. The multilayer composite of claim 1, wherein the barium strontium titanate of the formula (BaₓSr₁₋ₓ)Ti_{y}O_{z}, wherein 0≦x≦1.0, y is from about 0.50 to about 0.80 to about 1.30, and z is between from about 2.5 to about 3.5.

4. The multilayer composite of claim 3, wherein x is between from about 0.1 to about 0.9.

5. The multilayer composite of claim 4, wherein x is between from about 0.4 to about 0.75 and y is between from about 0.95 to about 1.05.

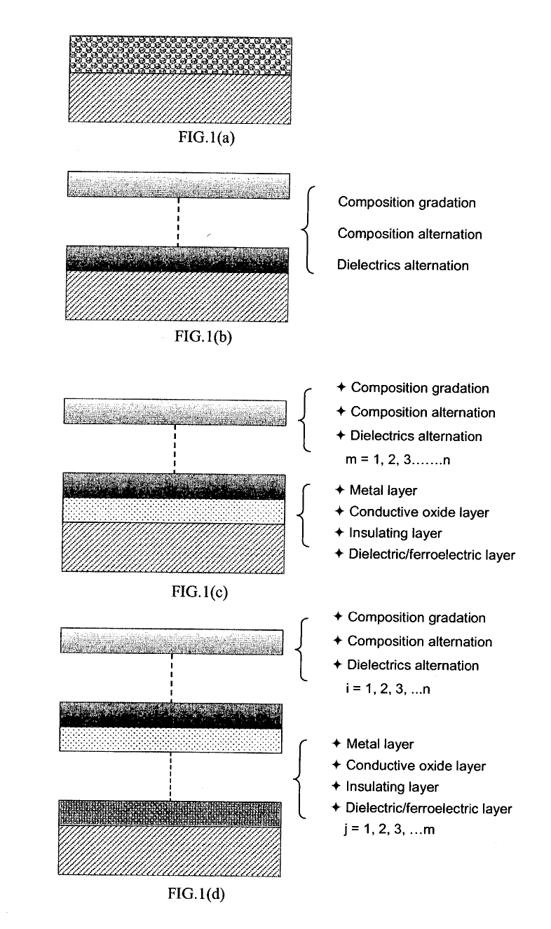

6. The multilayer composite of claim 1, wherein the dielectric thin film is composed of a single or multiple layers of barium strontium titanates with x composition gradation, or composition alternation, or same composition, as depicted in either FIGS. 1(a) and (b).

7. The multilayer composite of claim 1, wherein the multilayer composite has a thickness of from about 100 nm to about 1000 nm.

8. The multilayer composite of claim 1, wherein the barium strontium titanate has a perovskite structure.

9. The multilayer composite of claim 1, wherein the barium strontium titanate is principally of random orientation and is granular crystalline.

10. The multilayer composite of claim 1, wherein the metallic foil substrate is titanium, stainless steel, brass, nickel, copper, copper nickel or silver foil.

11. The multilayer composite of claim 1, wherein the metallic foil has a thickness less than 0.1 mm.

12. The multilayer composite of claim 10, wherein the metallic foil substrate is either a flat surface, texture surface or macroporous.

13. The multilayer structure of claim 2, wherein the barrier layer is interposed between the metallic foil substrate and the crystalline barium strontium titanate dielectric thin film as depicted in either FIG. 1(c), or 1(d).

14. The multilayer composite of claim 2, wherein the barrier layer comprises a metallic layer, a conductive oxide, a dielectric layer, or a ferroelectric layer.

15. The multilayer composite of claim 14, wherein the barrier layer has a thickness of from about 10 nm to about 2000 nm.

16. The multilayer composite of claim 14, wherein:
the metallic layer is selected from platinum, titanium or nickel;
the conductive oxide layer is selected from LaNiO₃, IrO₂, RuO₂, or La_{0.5}Sr_{0.5}CoO₃;
the dielectric layer is selected from TiO₂, Ta₂O₅, or MgO; and
the ferroelectric layer is selected from barium titanate, lead titanate, or strontium titanate.

17. The multilayer structure of claim 2, wherein the barium strontium titanate dielectric thin film and metallic foil substrate comprises a parallel interconnection of dielectrics and metallic foil.

18. The multilayer structure of claim 1, wherein the temperature at which the multilayer structure is formed is less than or equal to 650° C.

19. A capacitor comprised of the multilayer structure of claim 1.

20. The capacitor of claim 19, wherein the capacitor exhibits a capacitance density of about 200 to about 300 nF/cm² at 10 kHz frequency, a dielectric loss less than 3% at 10 kHz frequency, a leakage current density less than about 10⁻⁷ A/cm at a 5V operating voltage, and a breakdown field strength of from about 750 kV/cm to about 1.2 MV/cm at room temperature.
